(19) United States
(12) Patent Application Publication
(10) Pub. No.: US 2026/0084284 A1
(43) Pub. Date: Mar. 26, 2026

(54) MOBILE ROBOT ASSEMBLY SYSTEMS AND METHODS

(71) Applicant: Teledyne FLIR Defense, Inc., Thousand Oaks, CA (US)

(72) Inventors: James P. Lindsay, Chelmsford, MA (US); Carl H. Vonnegut, Chelmsford, MA (US); Jordan D. Jesiolowski, Methuen, MA (US)

(21) Appl. No.: 19/335,324

(22) Filed: Sep. 22, 2025

Related U.S. Application Data
(60) Provisional application No. 63/699,743, filed on Sep. 26, 2024.

(51) Int. Cl. B25J 5/00; B25J 19/00; B62D 55/02

(52) U.S. Cl. CPC B25J 5/007; B25J 5/005; B25J 19/0075; B62D 55/02

(57) ABSTRACT

A core chassis for a mobile robot assembly includes: a housing to enclose one or more electric motors; first wheel mounts to receive first wheels to be driven by the electric motor(s); one or more extension plate mounts to receive one or more extension plates to longitudinally displace second wheels relative to the housing and the first wheels. A flipper plate is rotatably driven when mounted to a main body of the robot. The flipper plate is bent to align a first flipper wheel mounted on the inner side of the flipper plate with a second flipper wheel mounted on the outer side of the flipper plate. The flipper plate has a first part proximate to the first flipper wheel, and a second part proximate to the second flipper wheel, and has a first link, a second link, and a middle link each of which rigidly connects the first part to the second part.

### CROSS REFERENCE TO RELATED APPLICATIONS

This application claims priority to and the benefit of U.S. Provisional Patent Application No. 63/699,743 filed Sep. 26, 2024 and entitled “MOBILE ROBOT ASSEMBLY SYSTEMS AND METHODS,” which is incorporated herein by reference in its entirety.

### TECHNICAL FIELD

One or more embodiments of the invention relate generally to mobile robot assemblies, and more particularly ground mobile robot assemblies, i.e. capable of moving on the ground (i.e. a solid surface).

### BACKGROUND

In military and industrial settings, personnel often encounter dangerous situations where intelligence of what lies ahead could save lives. Dismounted military patrols can use a lightweight, portable robot to maneuver into small spaces prone to ambush, and inspect potential threats, including suspected improvised explosive devices (IEDs). A small search robot can also be used to assess situations before exposing personnel to harm. In industrial settings, emergency personnel can preposition or insert a small inspection robot in hazardous spaces to evaluate the situation before humans enter the area. Such a robot can evaluate the extent of danger before rescue teams enter sealed areas in mining operations, chemical plants, or nuclear reactors.

A robot may have side flippers, which can rotate around their axles to assist the robot in stair climbing, obstacle surmounting, self-righting, and certain other behaviors. A flipper may have a driven flipper track trained about flipper driver wheels. The flipper track and wheels should be arranged to reduce the possibility of detracking when forces are applied to the flippers in mounting stairs or other operations.

### SUMMARY

In accordance with some embodiments, there is provided a system comprising a core chassis for a mobile robot assembly. The core chassis comprises: a housing configured to enclose one or more electric motors; a plurality of first wheel mounts configured to receive a plurality of first wheels to be driven by one or more of the electric motors; and one or more extension plate mounts configured to receive one or more extension plates to longitudinally displace a plurality of second wheels relative to the housing and the plurality of first wheels.

In accordance with some embodiments, there is provided a system comprising a flipper plate for a mobile robot. The flipper plate is configured to be rotatably driven and configured to be mounted to a main body of the robot. The flipper plate comprises: an outer side configured to face away from the main body, and an inner side opposite to the outer side. The flipper plate is bent to align a first flipper wheel mounted on the inner side of the flipper plate with a second flipper wheel mounted on the outer side of the flipper plate and with a track trained about the first and second flipper wheels. The flipper plate comprises: a first part configured to be proximate to the first flipper wheel, and a second part configured to be proximate to the second flipper wheel. The flipper plate comprises a first link, a second link, and a middle link each of which rigidly connects the first part to the second part, the middle link disposed between the first and second links.

Also provided are methods for manufacturing and using the robots and apparatuses described above.

Additional objects and advantages of the present teachings will be set forth in part in the description which follows, and in part will be obvious from the description, or may be learned by practice of the present teachings. The objects and advantages of the present teachings can be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate exemplary embodiments of the present teachings and together with the description, serve to explain the principles of those teachings.

### BRIEF DESCRIPTION OF THE DRAWINGS

FIG. 1 is a front, left, and top perspective view of a robot in accordance with an embodiment of the disclosure;

FIG. 2A is a rear, right, and top perspective view of a robot chassis in accordance with an embodiment of the disclosure;

FIG. 2B is a rear, left, and top perspective view of a robot with tracks removed in accordance with an embodiment of the disclosure;

FIGS. 3A, 3B are a rear, right, and top exploded view of a part of a robot chassis in accordance with an embodiment of the disclosure;

Each of FIGS. 4 and 5 is a rear, right and top of a part of a robot in accordance with an embodiment of the disclosure;

FIG. 6 is a top left perspective view of the left flipper in accordance with an embodiment of the disclosure;

FIG. 7 is a left side view of the right flipper without the flipper track in accordance with an embodiment of the disclosure;

FIG. 8 is a top view of the left flipper without the flipper track in accordance with an embodiment of the disclosure;

FIG. 9A is a top view of the left flipper without the flipper track and wheels in accordance with an embodiment of the disclosure;

FIG. 9B is a top view of the left flipper plate in accordance with an embodiment of the disclosure;

FIG. 10 is a left side view of the left flipper plate in accordance with an embodiment of the disclosure;

FIG. 11 is a left side view of the right flipper plate in accordance with an embodiment of the disclosure.

FIG. 12 is a left and top perspective view of the left flipper plate in accordance with an embodiment of the disclosure;

FIG. 13 is a side and top perspective view of a flipper main wheel and track in accordance with an embodiment of the disclosure;

### DESCRIPTION

Reference will now be made in detail to exemplary embodiments of the present teachings, examples of which are illustrated in the accompanying drawings.

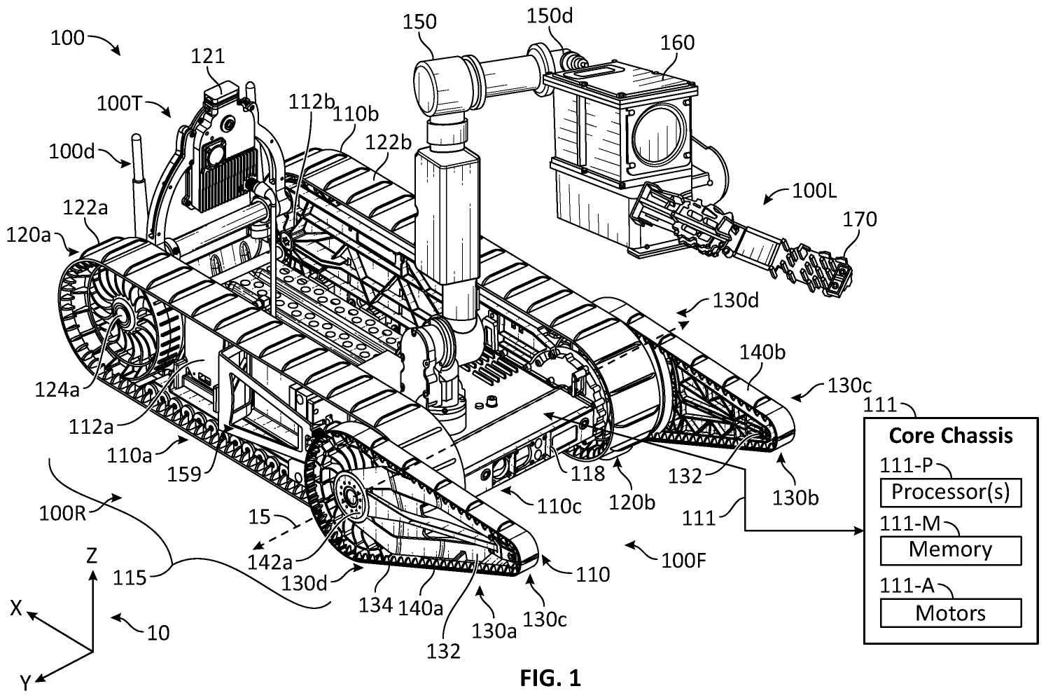

FIGS. 1-11 illustrate an example mobile robotic vehicle 100 that may be used as an unmanned ground vehicle capable of conducting operations in various environments such as urban terrain, tunnels, sewers, and caves. Moreover, the robot 100 may aid in the performance of urban Intelligence, Surveillance, and Reconnaissance (ISR) missions, chemical/Toxic Industrial Chemicals (TIC), Toxic Industrial Materials (TIM), and reconnaissance. The robot 100 shown includes a track driven drive system having flippers 130 (130a, 130b). The robot 100 may be portable, and may fit in a backpack.

The robot 100 can be designed to move about in a variety of environments, including an urban environment of buildings (including staircases), streets, underground tunnels, building ruble, and in vegetation, such as through grass and around trees. The robot 100 may have a variety of features which provide robust operation in these environments, including impact resistance, tolerance of debris entrainment, and invertible operability.

The robot 100 has a front side 100F, a rear side 100T, a right side 100R, and a left side 100L. The robot is described below with reference to the robot's Cartesian coordinate system 10 in which the X axis extends from front side 100F to the rear side 100T, the Z axis extends from the left side 100L to the right side 100R, and the Y axis is vertical extending from ground up (assuming the robot is on a horizontal surface).

The robot 100 includes a drive system 115 supported by a main body (chassis) 110. The main body 110 has right and left sides 110a, 110b as well as a front side 110c, and a rear side 110d.

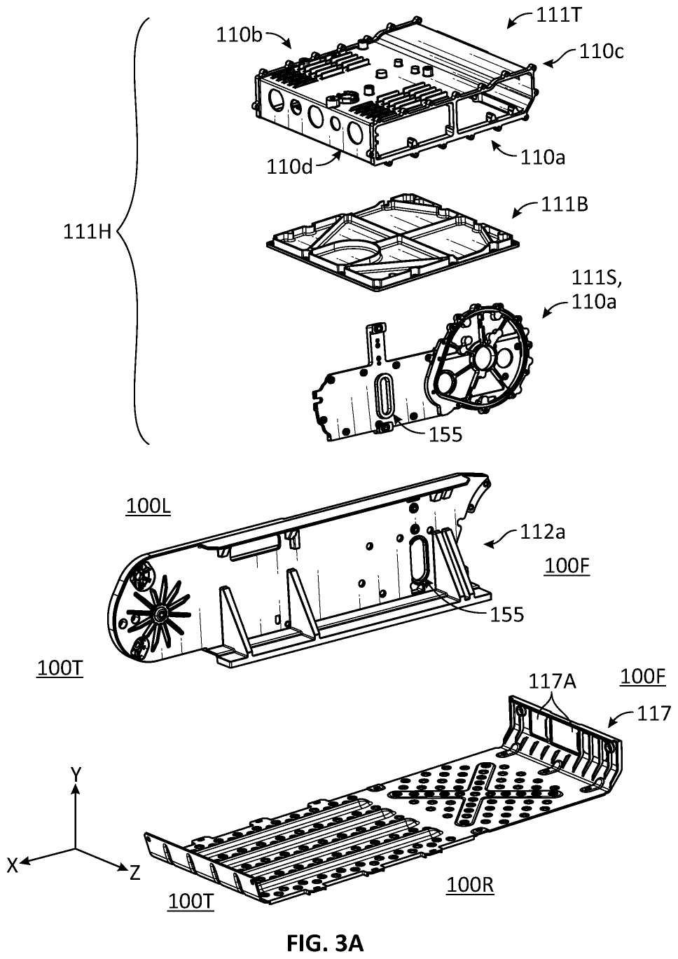

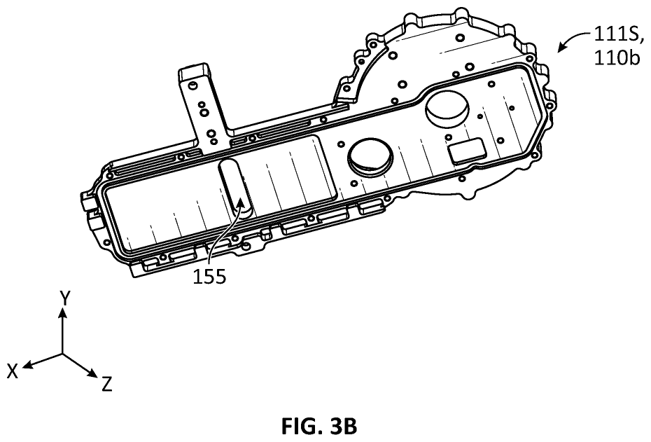

The main body (chassis) 110 has a variable (adjustable) length due to removable/replaceable extension plates 112a, 112b (FIGS. 1, 3A, 3B, 5) attachable to a core chassis 111 forming part of the main body 110. The core chassis 111 may or may not have a fixed length. The core chassis 111 includes a core housing 111H (a box or some other shape—see exploded view in FIG. 3A) that contains the robot electronics (e.g. a computer with one or more processors 111-P and memory 111-M; see FIG. 1) and also contains electric motors 111-A (e.g. electric actuators) for various mechanisms such as, for example, the drive system 115, another drive system that at least partially controls a manipulator arm 150, and possibly others. The housing 111H seals the core chassis 111 (i.e. the core chassis parts inside the housing 111H) to the environment from water, dust, and electromagnetic interference (EMI). The housing 111H may be metal, constructed with metal plates or other metal parts that serve as a Faraday cage. Other electrically conductive, preferably light-weight materials can be used instead or in addition to metal. A combination of electrically conductive and insulator materials can be used, with the electrically conductive material being preferably continuous to provide a Faraday cage. For example, in some embodiments, the electrically conductive material is present in the front, rear, top, bottom, right, and left surfaces of the housing (the terms such as “top” and “bottom” assume that the robot 100 is in a horizontal orientation with the drive system at the bottom as in FIG. 1).

As shown in FIGS. 3A and 3B, one embodiment of the housing 111H includes top box 111T, bottom plate 111B, and two symmetric side plates 111S. The right-side plate 111S is shown in FIG. 3A, and the left-side plate 111S is shown in FIG. 3B. Various apertures are provided in the core chassis 111 for bulkhead connections to communications (e.g. antennas) and/or other devices, for cameras and/or other sensors, axles/shafts driving the robot wheels and the flippers 130, and/or for fasteners used to fasten the extension plates 112 (112a, 112b) as well as manipulator arm(s) 150 and/or other parts of the robot 100. In some embodiments, all of these apertures are sealed from dust and water.

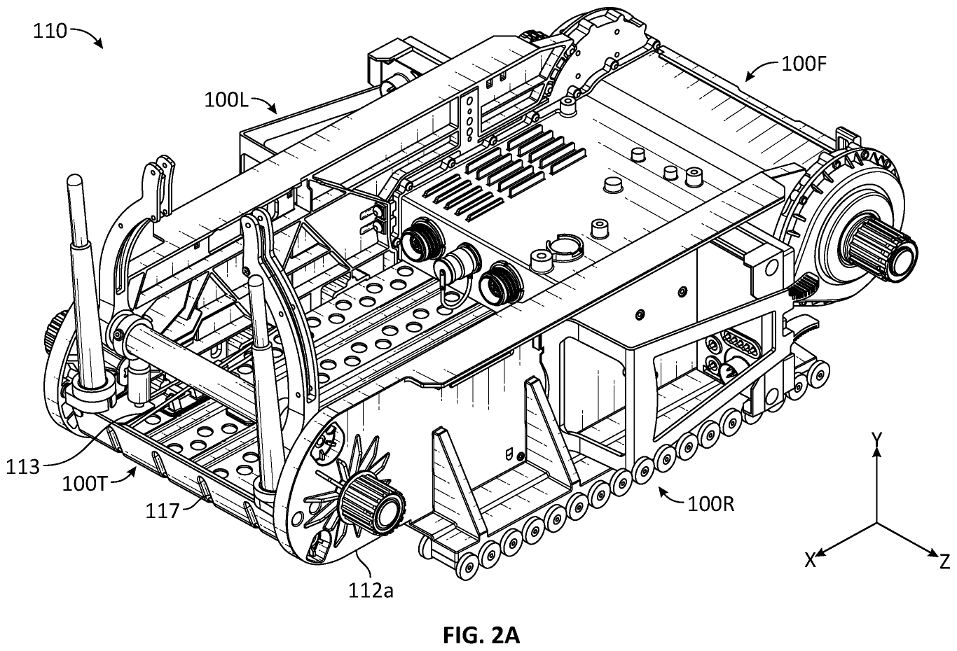

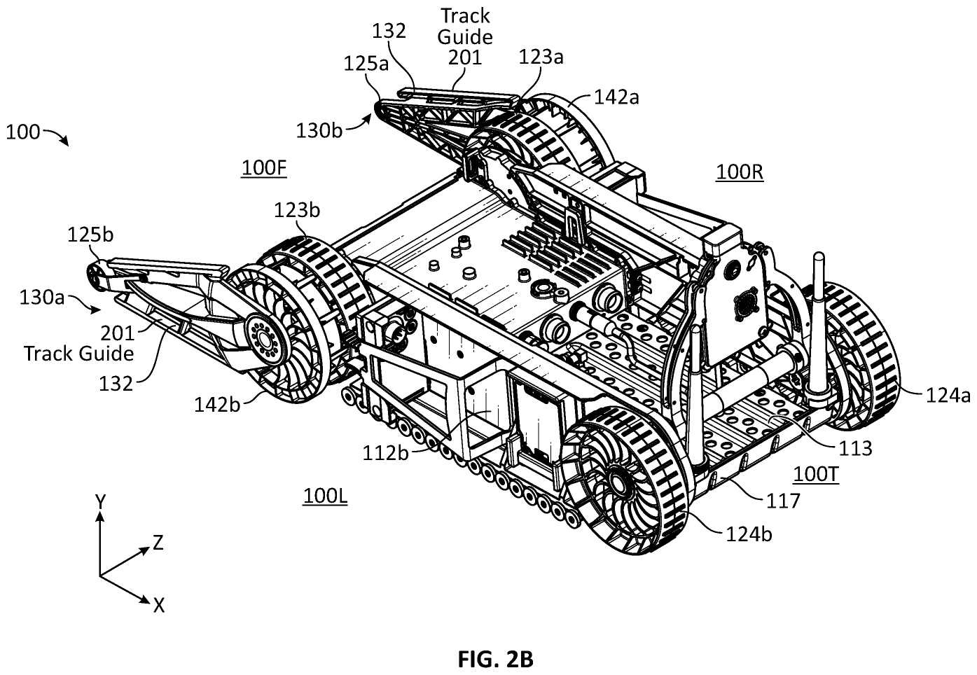

Behind the core chassis 111, stretching toward the rear side 100T, is a bay 113 (FIGS. 2A, 2B) that may be used in some embodiments to accommodate at least a part of manipulator arm 150 when the arm is in a stowed position. In addition or as an alternative, the bay 113 may receive other types of payloads or other devices, for example a sensor system 121 (FIG. 1) which can be stowed in the bay 113 or may be deployed as shown in FIG. 1. In some embodiments, the sensor system 121 includes front and rear view cameras, a microphone, a speaker, and/or other sensors or other devices.

The bay 113 is recessed relative to the top surface of the core chassis 111, and is bounded from below by a removable/replaceable floor panel 117 releasably fastened to the front and bottom surfaces of core chassis 111 and possibly to the side plates 111S and/or extension plates 112a, 112b. The floor panel 117 has a curved-up front side having apertures 117A (FIG. 3A) matching the apertures in top box 111T of core chassis 111. The floor panel 117 is also curved up at the rear side 110d.

Removable/replaceable side extension plates 112a, 112b are rigid plates disposed parallel to each other outwardly from core chassis 111 and releasably fastened to the outer surfaces of the respective right and left side plates 111S, at a point 410 (FIG. 4) and/or other points, by torque fasteners (e.g. threaded screws, for instance Phillips head screws), press-fit fasteners (e.g. pins), or some other type of releasable fasteners to allow easy replacement of the plates 112 to change the length and/or weight and/or other properties (rigidity, strength, etc.) of the main body 110. At least one transverse support 114 (FIG. 5) rigidly couples the right-side extension plate 112a to the left-side extension plate 112b. The extension plates 112a and 112b and the floor panel 117 can be replaced without much redesign of the robot to accommodate various use cases that may require a shorter or longer robot chassis. There is also a cost advantage and a development advantage for similar robots.

Rear idlers (free-spinning wheels) 124, i.e. 124a and 124b in FIG. 2B, are mounted to the extension plates 112 to support tracks 122a and 122b (FIG. 1). The side extension plates 112a, 112b and floor panel 117 do not need to be sealed from water, dust or EMI because the robot electronics is protected by the housing 111H.

The extension plates 112 and floor panel 117 are designed for strength and low weight, and can be molded plastic (e.g. polymers), lightweight metals, and/or composite materials.

In some embodiments, the extension plates 112 define the extent (length) of the portion of the chassis 110 behind the core chassis 111, and serve to longitudinally displace the rear wheels 124 relative to the housing 111H of the core chassis 111 and relative to robot front wheels 123 (123a, 123b). The floor panel 117 is optional, and may be attached to the core chassis 111 and/or extension plates 112 by releasable fasteners such as torque fasteners, press-fit fasteners, or other types.

The robot 100 may be electrically powered, e.g. by a bank of standard military BB-2590 replaceable and rechargeable lithium-ion batteries or some other kinds of batteries. The batteries are inserted into a bulkhead battery pass 155 (FIGS. 3A, 3B) passing through the core chassis 111 and plates 111S, 112a, 112b. Bulkhead battery pass 155 is bolted and sealed to the core chassis 111. The robot has flexible plastic straps 159 (FIG. 1), e.g. molded plastic, attached to the extension plates 112a, 112b to bias the batteries into the battery pass 155.

In some implementations, the drive system 115 includes right and left driven track assemblies 120a, 120b (FIG. 1), also referred to as the main track assemblies 120, mounted on the corresponding right and left sides 110a, 110b of the main body 110 and having the right and left driven tracks 122a, 122b respectively. Each driven track 122a, 122b is trained about a corresponding the front wheel 123 (123a, 123b in FIG. 2B), also called “main wheel”, which is driven to rotate about a drive axis 15 (FIG. 1). Each driven track 122a, 122b is also trained about a corresponding free-spinning rear wheel 124 (124a, 124b in FIG. 2B). Although the robot 100 is depicted as having skid steer driven tracks, other drive systems are possible as well, such as differentially driven wheels, articulated legs, and the like.

The main body 110 may include one or more cameras 118 (FIG. 1) disposed near the front side 110c of the main body 110 and possibly positioned to have a field of view directed forward and/or upward. The camera(s) 118 may capture images and/or video of the robot environment for navigating the robot 100 and/or performing specialized tasks, such as maneuvering through tunnels, sewers, and caves, etc.

The robot 100 may include one or more robotic manipulator arms 150 (e.g., articulated arms) each having a pivot end pivotally coupled to the main body 110, possibly to the core chassis 111, and a distal end 150d that may be configured to receive a head 160 or a gripper 170 or both. The arm 150 may be coupled to the core chassis 111 in a manner that allows the arm 150 to be stowed along the main body 110 in a compact configuration and pivot away from main body 110 to allow a wider range of CG-shifting, for example, to negotiate obstacles.

As shown in FIG. 1, head 160 and gripper 170 are mounted on the distal end 150d of the arm 150. The arm 150 has an arm center of gravity CGA and the head 160 has a center of gravity CGH. The head 160 may include a visible light camera and/or infrared camera and/or some other spectrum camera, radar, LIDAR (Light Detection And Ranging, which can entail optical remote sensing that measures properties of scattered light to find range and/or other information of a distant target), LADAR (Laser Detection and Ranging), a communication device (radio frequency, wireless, etc.), and/or other components.

To achieve reliable and robust autonomous or semi-autonomous movement, the robot 100 may include a sensor system (including sensor system 121) having several different types of sensors. The sensors can be used in conjunction with one another to create a perception of the robot's environment (i.e., a local sensory perception) sufficient to allow a control system for the robot 100 to determine actions to take in that environment. The sensor system may include one or more types of sensors supported by the robot body 110, which may include obstacle detection obstacle avoidance (ODOA) sensors, communication sensors, navigation sensors, and so on.

For example, these sensors may include proximity sensors, contact sensors, cameras (e.g., volumetric point cloud imaging, three-dimensional (3D) imaging or depth map sensors, visible light camera and/or infrared camera), sonar (e.g., ranging sonar and/or imaging sonar), radar, LIDAR (Light Detection And Ranging, which can entail optical remote sensing that measures properties of scattered light to find range and/or other information of a distant target), LADAR (Laser Detection and Ranging), laser scanner, ultrasound sensor, and so on.

The robot 100 includes at least one extendable flipper 130 (right flipper 130a and left flipper 130b in FIGS. 1 and 2B) mounted to the main body 110. In some examples, the flippers 130 are releasable, to allow the robot 100 to be used with or without the flippers 130. FIG. 1 shows the right and left flippers 130a, 130b in an extended configuration extending beyond the front side 110c of the main body 110.

The flippers 130 (130a, 130b) each have a distal end 130c and a pivot end 130d. Each flipper 130a, 130b includes a flipper plate (main body) 132 that pivots about the drive axis 15 near the front side 110c of the main body 110. For example, the flippers 130 may be driven by a shaft 131 (FIGS. 4, 5) passing through the core chassis 111 and rigidly attached to both of the flippers plates 132. The shaft 131 is driven by a motor 111-M. In such implementations, the flippers 130 (including the flipper plates 132) rotate in unison in a continuous 360 degrees between a stowed position, in which the flippers 130a, 130b are next to the right and left extension plates 112a, 112b of the main body 110, and at least one deployed position, in which the flippers 130a, 130b are pivoted at an angle with respect to the main tracks 122a, 122b (as in FIG. 1 or 2B for example). The center of gravity CGR of the robot 100 can be contained within an envelope of the 360 degree rotation of the flippers 130a, 130b to lift up the robot front side 110c and the front end of the core chassis 111 to climb stairs or for other operations when the flippers 130 are in an extended configuration extending beyond the front side 110c of the main body 110. The flippers 130 raise the robot rear side 110d and the rear end of the core chassis 111 when the flippers rotate while pointing backward, i.e. extending next to the main body 110.

Each flipper 130 includes a track 140 (140a or 140b) trained around the flipper's wheels 142, 125 as described below.

The combination of main track assemblies 120a, 120b and flippers 130a, 130b provides an extendable drive base length to negotiate gaps in a supporting surface. In some examples, the right main track 122a and the right flipper track 140a are driven in unison and the left main track 122b and the left flipper track 140b are driven in unison to provide a skid steer drive system.

Alternatively, a separate shaft 131 can be provided for each flipper to allow the flippers to pivot independently of each other.

Each flipper 130a, 130b may have a driven flipper track 140a, 140b trained about a corresponding flipper drive wheel 142a, 142b (FIGS. 1, 2B), which is concentric with the corresponding drive wheel 123a, 123b. The flipper track 140a, 140b is driven about the drive axis 15 at the pivot end 130d of the flipper 130a, 130b. Each flipper drive wheel 142a, 142b may be driven by a corresponding shaft/axle 223 (FIGS. 4, 5) serving as a wheel mount for the corresponding flipper wheel 142 (142a or 142b). The shaft 223 also drives the corresponding adjacent robot front wheel 123a, 123b and serves as a wheel mount for the corresponding robot wheel 123a, 123b. Separate, independently driven shafts 223 are provided for the respective flipper drive wheels 142a, 142b and hence for respective robot drive wheels 123a, 123b. Each shaft 223 and a corresponding protruding portion of shaft 131 serve as a flipper mount for the corresponding flipper 130. The shafts 223 are driven by respective motors 111-M. The robot wheels 123 are separated from the corresponding plates 111S by respective gears (not shown) and gear covers 500 (FIGS. 4, 5).

Each flipper track 140a, 140b is also trained about the corresponding flipper tip wheel 125a, 125b, which is free-spinning in some embodiments.

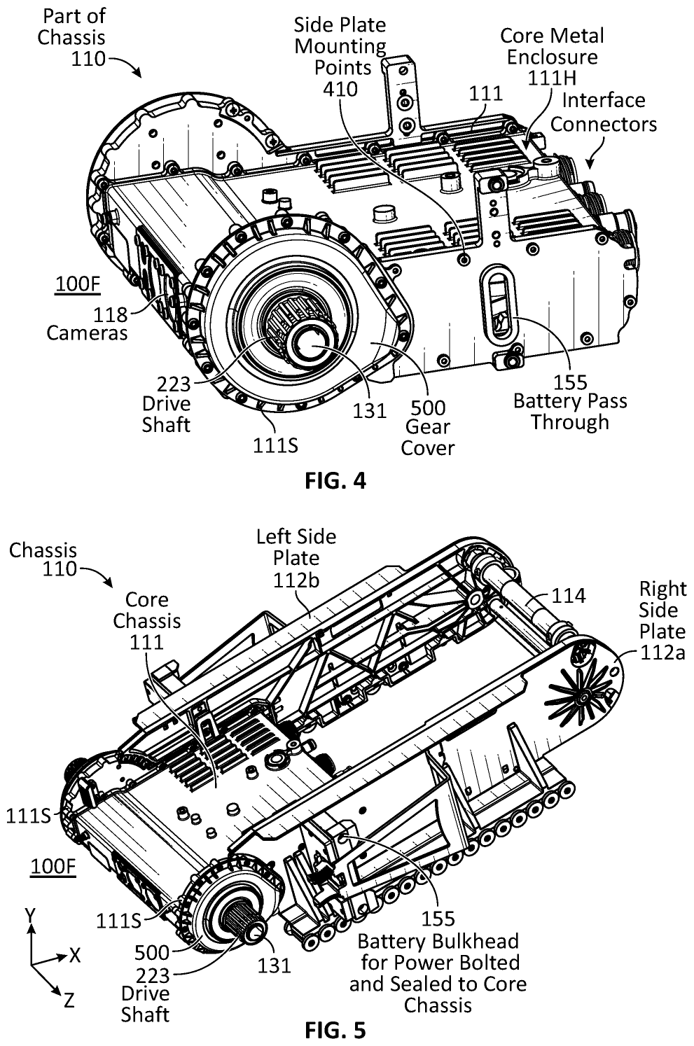

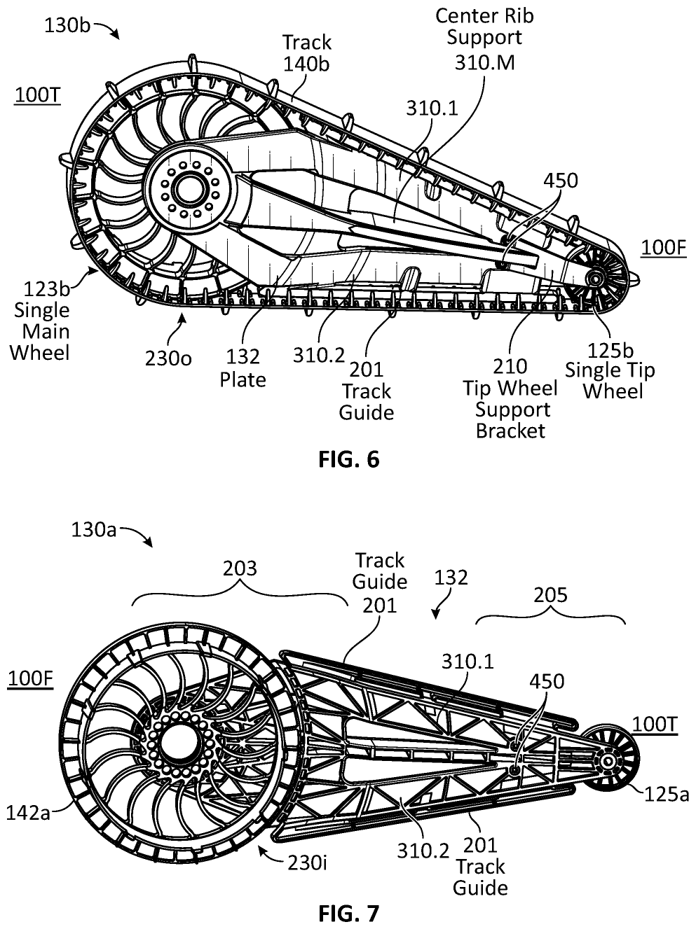

The main body of each flipper 130 is formed by the corresponding flipper plate 132 (FIGS. 6-11), which includes two flipper track guides 201 supporting and guiding the corresponding flipper track 140. In some embodiments, each track guide 201 has a smooth, straight-line (rectangular), planar surface (track guiding surface) adjacent to, and possibly physically contacting, the corresponding flipper track 140. The flipper track 140 may have pins or other retainers 580 (FIG. 13) positioned on the sides of the corresponding track guiding surface to reduce the probability of detracking. Each wheel 142 has protrusions 590 (FIG. 13) that engage the retainers 580 to drive the track 140.

The drive axis 15 is the axis of symmetry of the concentric shafts 223 and 131. The shaft 131 passes inside the shafts 223 and protrudes out of the shafts 223 to rigidly connect to the flipper plates 132.

The center of gravity of the core chassis 111 is rearward of the drive axis 15 (assuming the core chassis 111 is in a horizontal orientation as in FIG. 1). Therefore, the robot main wheels 123 are insufficient to support the rear end of the core chassis 111 above ground (except if the main wheels 123 are heavy). However, the combination of robot main wheels 123 and rear wheels 124 is sufficient to support the core chassis 111 in its entirety above ground in at least the horizontal orientation.

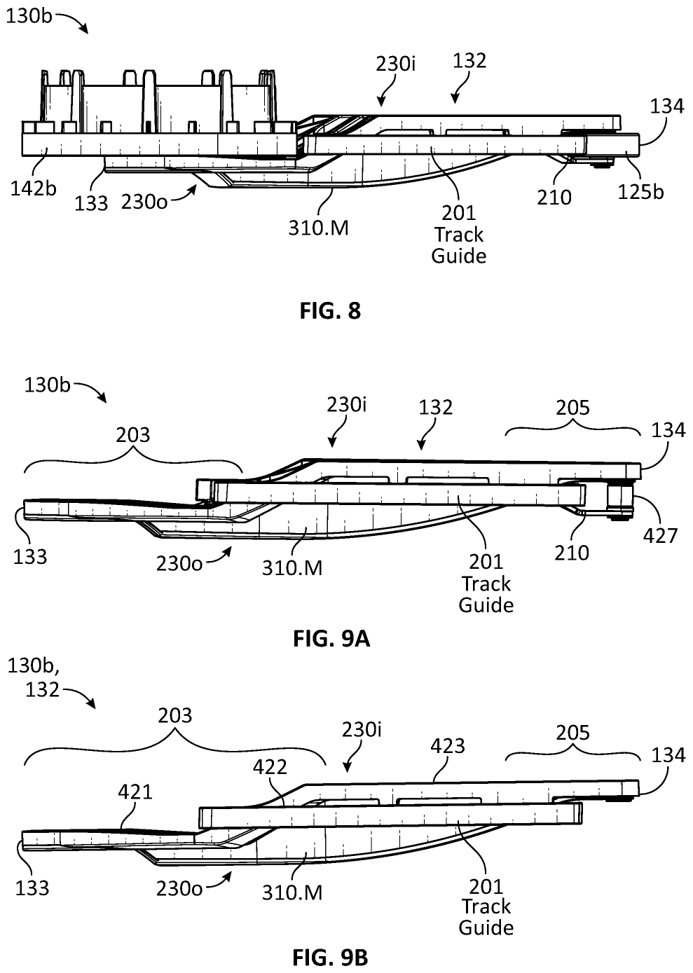

In the embodiments of FIGS. 6-11, the flippers 130a, 130b are reflection-symmetric to each other relative to the vertical plane parallel to the XY plane (FIG. 1) passing from the front side 100F to the rear side 100T through the middle of the robot. FIGS. 6, 10, and 12 include side views of outer side 230o of the flipper 130b, i.e. the side facing away from the robot. FIGS. 7, 11, and 13 include side views of inner side 230i of the flipper 130a, i.e. the side toward the main body 110. The sides 230o, 230i are opposite from each other. FIGS. 8, 9A, 9B are top views of the flipper 130b (the term “top” assumes the flipper is in the horizontal extended configuration extending beyond the front side 110c of the main body 110 as in FIG. 1).

As is seen in FIG. 8, the flipper wheels 142, 125 are disposed on the respective opposite sides 230i, 230o of the flipper plate 132: the main flipper wheel 142 is on the inner side 230i; and the tip wheel 125 is on the outer side 230o. The flipper plate 132 is suitably bent, as described in more detail below, to avoid detracking, i.e. slipping of the flipper track 140 off the flipper wheels 125, 142. In particular, the track-guiding (track-contacting) rims of flipper wheels 142, 125 are aligned with each other, being positioned in substantially the same vertical plane (assuming the robot is horizontal as in FIG. 1). The same vertical plane also passes through and along the track guiding surfaces of the track guides 201. The flipper plate 132 has two track guides 201 running from the main flipper wheel 142 (and an adjacent end 133 of the flipper plate 132) to the tip wheel 125 (and an adjacent end 134 of the flipper plate 132). The track guiding surfaces of the track guides 201 are aligned in approximately a straight line with the flipper wheels 142, 125. The track guiding surfaces contact the track 140 at the top and bottom of the flipper plate 132. The track guiding surfaces do NOT bend between the flipper wheels 142, 125.

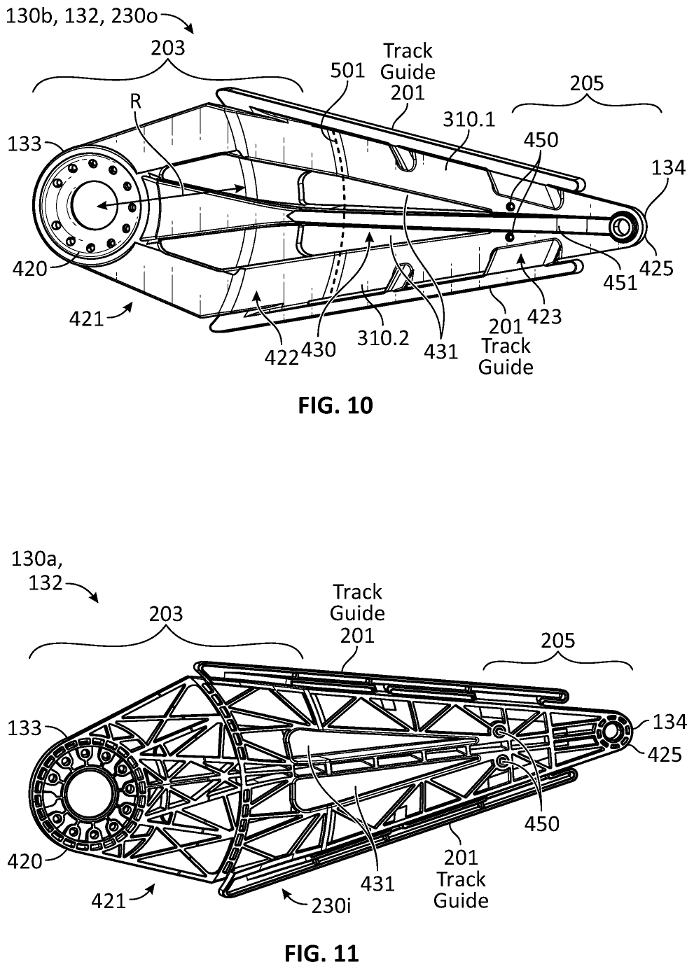

The flipper plate 132 has a first part 203 proximate to the main flipper wheel 142 and extending from the first flipper plate end 133 toward the tip wheel 125. The flipper plate 132 has a second part 205 proximate to the flipper tip wheel 125 and extending from the second flipper plate end 134 toward the main flipper wheel 142. The first and second parts 203, 205 are rigidly connected to each other by each of links 310.1 and 310.2 (FIGS. 10, 11, 12) that are proximate to respective top and bottom longitudinal edges of the flipper plate 132 and to the respective track guides 201. The first and second parts 203, 205 are also rigidly connected to each other by a middle link (rib support) 310.M running between the links 310.1 and 310.2. The first part 203 and/or the links 310.1, 310.2 bend to avoid detracking as described herein. The middle link 310.M does not follow the bending profile of the first part 203 and/or the links 310.1, 310.2, and serves to reinforce the flipper 130 as described below.

As shown in FIGS. 10, 11, and 12, the middle link 310.M is separated by a gap (through-hole) 431 from the link 310.1 and by another gap (through-hole) 431 from the link 310.2. The gaps 431 help reduce the flipper plate weight. The middle link 310.M strengthens the flipper plate against forces generated when the tip wheel 125 impacts an object. In some embodiments, the links 310.1, 310.2 have a uniform thickness (the thickness being measured from the inner side 230.i to the outer side 230.o of the flipper plate 132, i.e. as the vertical dimension in FIGS. 8, 9A, 9B). The middle link 310.M may be thicker than 310.1, 310.2 at least near the middle between the flipper plate ends 133, 134, and may be thicker in the middle than near the parts 203, 205. In some embodiments, the middle link 310.M is not as wide as (i.e. is narrower than) any of the links 310.1, 310.2, the width being measured as a vertical dimension in FIGS. 6-7 and 10-11.

The first part 203 extends from the first flipper plate end 133 to the gaps 431. The second part 205 extends from the second flipper plate end 134 to the gaps 431.

In the embodiment shown, the tip wheel 125 has a smaller diameter than the main flipper wheel 142, and the flipper plate 132 is substantially triangular—the links 310.1, 310.2 merge with the middle link 310.M at the part 205. The gaps 431 are also substantially triangular.

The first part 203 has a ring-like structure 420 (FIGS. 10, 11, 12) concentric with the flipper main (driven) wheel 142 and with the shaft 131 (FIGS. 4, 5) and rigidly connected to the shaft 131. The second part 205 has a ring-like structure 425 concentric with the tip wheel 125. Each of the rings 420, 425 may or may not be planar. For example, the ring 420 may be convex (like a truncated sphere or truncated cone or some other shape). The ring 420 is part of a sector-shape structure (“sector”) 421 having a radius R (FIG. 10) slightly larger than the main flipper wheel 142. The sector 421 is substantially parallel to the main flipper wheel 142, facing the main flipper wheel 142 and extending slightly beyond the main flipper wheel 142 toward the second part 205. At the end of sector 421, the flipper plate 132 portion including the first part 203 and/or the links 310.1, 310.2 bends to form an inclined section (“incline”) 422, which may (or may not) be substantially planar. Incline 422 extends toward the robot main body 110 up to a position marked by a dashed line 501 in FIG. 10. At this position, the flipper plate 132 (including the first part 203 and/or the links 310.1, 310.2) bends back to form a substantially planar section 423 substantially parallel to the sector 421 and including the ring 425. The links 310.1, 310.2 lie partially in the section 423 and partially in the incline 422. In other embodiments, the links 310.1, 310.2 lie entirely in the section 423, and the incline 422 lies entirely in the first part 203. In still other embodiments, the links 310.1, 310.2 lie entirely or partially in the incline 422 and/or sector 421.

The middle link 310.M may protrude out at the outer side 230o. The middle link 310.M may be level with the second side 205 at the inner side 230i, or may protrude out at the inner side 230i to come closer to the robot main body 110 than the second part 205.

The first and second parts 203, 205 and the first and second links 310.1, 301.2 define a substantially triangular area 430 bounded thereby. The middle link 310 divides the area 430 into the two halves 431 on opposite sides of middle link 310.M. The first and second parts 203, 205 and the first and middle links 310.1, 310.M define the through-hole 431 bounded thereby. The first and second parts 203, 205 and the second and middle links 310.2, 310.M define the other through-hole 431 bounded thereby.

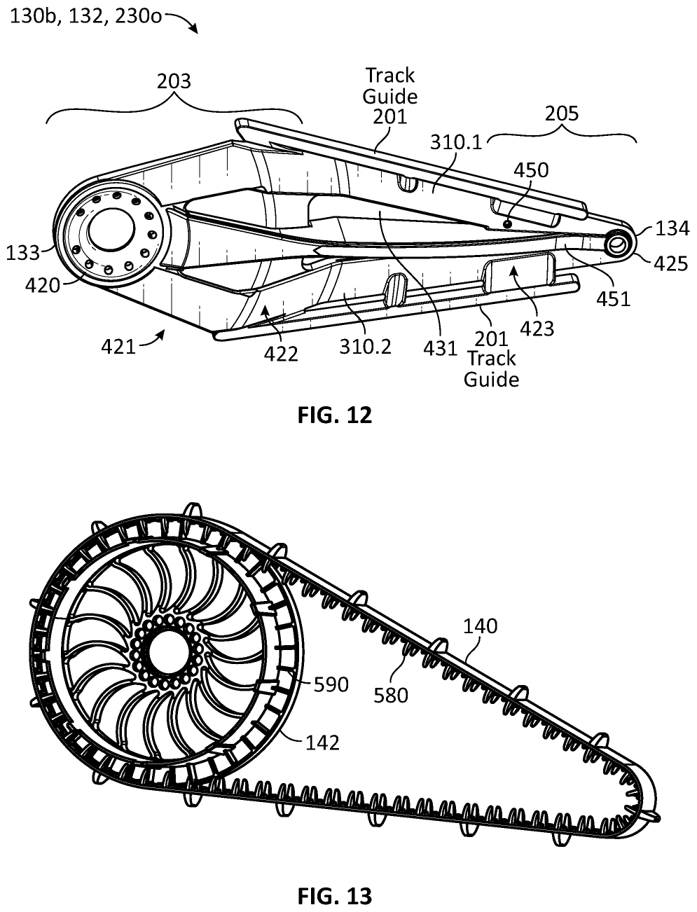

The second part 205 has a protrusion 451 (FIGS. 10, 12) on the outer side 230o. This protrusion is a continuation of the middle link 310.M. The flipper plate 132 includes two mounting structures 450 (FIGS. 6, 7, 10, 11) on the opposite sides of the protrusion 451. The mounting structures 450 can be mounting holes, for example, for fastening a bracket 210 (FIGS. 6, 8, and 9A) supporting the flipper tip wheel 125 from the outer side 230o. The bracket 210 (possibly stainless steel) overlies and abuts the protrusion 451, contacting the protrusion 451 at a point at which the protrusion 451 is receding. This structure resists forces generated against the flipper 130 when the tip wheel 125 impacts an object. The flipper tip wheel 125 may be mounted on an axle/shaft 427 (FIG. 9A) having one end inserted into the ring 425 and the other end inserted into a hole in the bracket 210. The bracket 210 interacts with the middle link 310.M (through the protrusion 451) to strengthen the flipper 130 against forces applied against the flipper when the second part 205 and/or the flipper tip wheel 125 impact an object.

The invention is not limited to the embodiments described above. Some embodiments include a mobile robot assembly comprising a core chassis comprising: a housing; core chassis parts within the housing, the core chassis parts comprising a processor, a memory, and one or more electric motors; a plurality of first wheel mounts for mounting a plurality of first wheels outside the housing to be driven by one or more of the electric motors, the plurality of first wheels being configured to partially support the core chassis above ground, the plurality of first wheels being insufficient to support all of the core chassis above ground in at least a horizontal orientation of the core chassis due at least in part to a relative position of the core chassis center of gravity relative to the first wheel mounts; and one or more extension plate mounts for releasably mounting one or more extension plates to the housing to extend past the housing, the one or more extension plates being configured for mounting a plurality of second wheels to the extension plates. The mounted first and second wheels are sufficient to support all of the core chassis above the ground at least when the core chassis is in the horizontal orientation.

Some embodiments include an apparatus comprising a flipper plate for a robot. The flipper plate is configured to be rotatably driven and configured to be mounted to a main body of the robot. The flipper plate has an outer side configured to face away from the main body and has an inner side opposite to the outer side. The flipper plate is bent to align a first flipper wheel mounted on the inner side of the flipper plate with a second flipper wheel mounted on the outer side of the flipper plate and with a track trained about the first and second flipper wheels. The flipper plate has a first part configured to be proximate to the first flipper wheel, and has a second part configured to be proximate to the second flipper wheel. The flipper plate comprises a first link, a second link, and a middle link each of which rigidly connects the first part to the second part, the middle link running between the first and second links.

The robot embodiments described herein can also include additional components that were omitted from the drawings for clarity of illustration and/or operation. Accordingly, this description is to be construed as illustrative only and is for the purpose of teaching those skilled in the art the general manner of carrying out the present teachings. It is to be understood that the various embodiments shown and described herein are to be taken as exemplary. Elements and materials, and arrangements of those elements and materials, may be substituted for those illustrated and described herein, parts may be reversed, and certain features of the present teachings may be utilized independently, all as would be apparent to one skilled in the art after having the benefit of the description herein. Changes may be made in the elements described herein without departing from the spirit and scope of the present teachings and following claims, including their equivalents.

It is to be understood that the particular examples and embodiments set forth herein are non-limiting, and modifications to structure, dimensions, materials, and methodologies may be made without departing from the scope of the present teachings.

For the purposes of this specification and appended claims, unless otherwise indicated, all numbers expressing quantities, percentages or proportions, and other numerical values used in the specification and claims, are to be understood as being modified in all instances by the term “about” if they are not already. Accordingly, unless indicated to the contrary, the numerical parameters set forth in the following specification and attached claims are approximations that may vary depending upon the desired properties sought to be obtained by the present teachings. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

It should be understood that while the present teachings have been described in detail with respect to various exemplary embodiments thereof, it should not be considered limited to such, as numerous modifications are possible without departing from the broad scope of the appended claims, including the equivalents they encompass.

What is claimed is:

1. A system comprising:
a core chassis for a mobile robot assembly, the core chassis comprising:
a housing configured to enclose one or more electric motors;
a plurality of first wheel mounts configured to receive a plurality of first wheels to be driven by one or more of the electric motors; and
one or more extension plate mounts configured to receive one or more extension plates to longitudinally displace a plurality of second wheels relative to the housing and the plurality of first wheels.

2. The system of claim 1, wherein:
the system is a mobile robot;
the housing seals the core chassis to the environment from water, dust, and electromagnetic interference (EMI); and
the system further comprises:
the electric motors;
the first wheels configured to at least partially support the chassis above ground;
the extension plates; and
the second wheels, wherein the first and second wheels are sufficient to collectively support the chassis above the ground.

3. The system of claim 1, wherein:
the one or more extension plates are configured to be releasably mounted to the housing at the one or more extension plate mounts;
the plurality of first wheels are configured to partially support the core chassis above ground, the plurality of first wheels being insufficient to support all of the core chassis above ground in at least a horizontal orientation of the core chassis due at least in part to a relative position of the core chassis center of gravity relative to the first wheel mounts;
wherein the mounted first and second wheels are sufficient to support all of the core chassis above the ground at least when the core chassis is in the horizontal orientation.

4. The system of claim 1, wherein the core chassis further comprises flipper mounts attached to the housing, for supporting a plurality of flippers;
wherein each of the plurality of flippers is rotatably connected to a right or left side of the housing, each of the plurality of flippers being configured to be driven by at least one of the one or more electric motors to rotate in a first direction to raise a rear end of a robot chassis comprising the core chassis and the extension plates, and to rotate in a second and opposite direction to raise a front end of the robot chassis.

5. The system of claim 1, wherein the housing further comprises one or more floor panel mounts configured to receive a floor panel extending past the housing for supporting a payload.

6. A method of using the system of claim 5, the method comprising supporting a payload by the one or more extension plates and/or the floor panel.

7. A system comprising:
a flipper plate for a mobile robot, wherein:
the flipper plate is configured to be rotatably driven and configured to be mounted to a main body of the robot, the flipper plate comprising: an outer side configured to face away from the main body, and an inner side opposite to the outer side;
the flipper plate is bent to align a first flipper wheel mounted on the inner side of the flipper plate with a second flipper wheel mounted on the outer side of the flipper plate and with a track trained about the first and second flipper wheels;
the flipper plate comprises: a first part configured to be proximate to the first flipper wheel, and a second part configured to be proximate to the second flipper wheel; and
the flipper plate comprises a first link, a second link, and a middle link each of which rigidly connects the first part to the second part, the middle link disposed between the first and second links.

8. The system of claim 7, wherein:
the system is a mobile robot;
the flipper plate comprises a first edge stretching between the first and second wheels proximate to a first stretch of the track, and comprises a second edge opposite to the first edge and stretching between the first and second wheels proximate to a second stretch of the track; and
wherein the first link is proximate to the first edge, and the second link is proximate to the second edge.

9. The system of claim 7, wherein the first and second parts and the first and second links define an area bounded thereby, and the middle link runs through the middle of the area to divide the area into two halves.

10. The system of claim 7, wherein the first and second parts and the first and middle links define a through-hole bounded thereby, and the first and second parts and the second and middle links define a through-hole bounded thereby.

11. The system of claim 7, wherein the flipper plate comprises a first portion configured to face the first wheel and extend substantially in a first plane, a second portion configured to face the second wheel and extend substantially in a second plane parallel to the first plane, and a third portion extending from the first plane to the second plane.

12. The system of claim 11, wherein the middle link reaches the first and second planes and protrudes out of the first plane.

13. The system of claim 7, wherein the middle link is thicker than the first and second links, the thickness being measured from the inner side to the outer side of the flipper plate.

14. The system of claim 13, wherein the flipper plate further comprises two mounting structures on opposite sides of a member comprising the middle link for affixing a bracket overlying the member on the outer side and supporting the second wheel from the outer side, the bracket strengthening the flipper against forces applied against the flipper when the second part and/or the second wheel impact an object.

15. The system of claim 13, wherein the middle link is not as wide as any of the first and second links, the width being measured as parallel to the first and second planes and perpendicular to a length extending from the first part to the second part.

16. The system of claim 7, wherein the flipper plate comprises a first track guiding surface and a second track guiding surface each of which is a straight-line, planar surface configured to contact and guide the track between the first and second wheels.

17. A method of using the system of claim 7, the method comprising driving the first and second flipper wheels to drive the system.

18. A method comprising:
obtaining a core chassis for a mobile robot, the core chassis comprising:
a housing; and
core chassis parts within the housing, the core chassis parts comprising a processor, a memory, and one or more electric motors;
mounting a plurality of first wheels outside the housing to be driven by one or more of the one or more electric motors, the plurality of first wheels being configured to partially support the core chassis above ground, the plurality of first wheels being insufficient to support all of the core chassis above ground in at least a horizontal orientation of the core chassis due at least in part to a relative position of the core chassis center of gravity relative to the first wheel mounts;
releasably mounting one or more first extension plates to the housing to extend past the housing, the one or more first extension plates extending past the housing by a first amount; and
mounting a plurality of second wheels to the first extension plates;
wherein the mounted first and second wheels support all of the core chassis above the ground at least when the core chassis is in the horizontal orientation.

19. The method of claim 18, further comprising:
releasing the one or more first extension plates from the mobile robot;
releasably mounting one or more second extension plates to the housing, the one or more second extension plates extending past the housing by a second amount different than the first amount; and
mounting the plurality of second wheels or a plurality of third wheels to the one or more second extension plates;
wherein the mounted second or third wheels support the core chassis in its entirety above ground at least when the core chassis is in the horizontal orientation.

20. The method of claim 18, wherein the housing seals the core chassis to the environment from water, dust, and electromagnetic interference (EMI).
